(19) United States
(12) Patent Application Publication
(10) Pub. No.: US 2005/0192818 A1
(43) Pub. Date: Sep. 1, 2005

(54) Method of selling nuts

(76) Inventor: Donald K. Cox, Phoenix, AZ (US)

Correspondence Address: WEISS & MOY PC, 4204 NORTH BROWN AVENUE, SCOTTSDALE, AZ, 85251, US

(21) Appl. No.: 10/787,807

(22) Filed: Feb. 26, 2004

(51) Int. Cl. G06F 17/60

(52) U.S. Cl. 705/1

(57) ABSTRACT

A method for selling nuts to consumers by associating an interest category with a container of nuts is disclosed. The method of selling nuts increases the overall sale and consumption of nuts by associating an interest category with the word “nut” or “nuts” on a container of nuts in order to encourage the sale of nuts to individuals or groups having a specific interest.

### FIELD OF THE INVENTION

This invention relates generally to methods for doing business and, more particularly, to a method for selling nuts to consumers by associating an interest category with a container of nuts.

### BACKGROUND OF THE INVENTION

Nuts, such as peanuts, almonds, walnuts, cashews, and pistachio nuts, possess many health benefits. Nuts have been discovered to be an excellent source of vitamin E, protein, fiber, zinc, selenium, copper, magnesium, potassium, phosphorus, biotin, niacin, riboflavin, and iron. Epidemiological studies have also suggested that including nuts in one's diet decreases the risks of cardiovascular diseases, such as coronary heart disease, congestive heart failure, hypertensive heart disease, stroke, and renal failure.

Due to the many health benefits of consuming nuts, it is important to increase the distribution and sale of nuts in order to increase their consumption. It is often the case, however, that nuts are only sold in the snack food sections of grocery stores and supermarkets. Selling nuts in additional locations, such as novelty stores and specialty stores, and associating nuts with different categories of interest, increases the overall number of people purchasing nuts, and consequently increases the overall consumption of nuts.

A need therefore existed for a method of selling nuts capable of associating a container of nuts with an interest category in order to increase the number of people exposed to nuts which, subsequently, increases the overall sale and consumption of nuts.

### SUMMARY OF THE INVENTION

It is an object of the present invention to provide a business method for selling nuts by associating a container of nuts with an interest category.

Other objects, features and advantages of the present invention will become apparent from a consideration of the following detailed description.

### BRIEF DESCRIPTION OF THE PREFERRED EMBODIMENTS

In accordance with one embodiment of the present invention, a method of selling nuts is disclosed. The method comprises, in combination, the steps of: providing a container having at least one nut, selecting an interest category, affixing the interest category to the container so as to associate the container of the at least one nut with the interest category, and selling the container of the at least one nut.

In accordance with another embodiment of the present invention, a method of selling nuts is disclosed. The method comprises, in combination, the steps of: providing a container having at least one nut, selecting an interest category, affixing the interest category to the container proximate one of words “nut”, “nuts” and “nuts for” so as to associate the container of the at least one nut with the interest category, and selling the container of the at least one nut.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a perspective view of one embodiment of the present invention, showing a jar holding nuts with the interest category of “sports” affixed proximate the word “nut”.

FIG. 2 is a perspective view of one embodiment of the present invention, showing a jar holding nuts with the interest category of “golf” affixed proximate the word “nut”.

FIG. 3 is a perspective view of one embodiment of the present invention, showing a bag holding nuts with the interest category of “nuts” affixed proximate the words “nuts for”.

FIG. 4 is a perspective view of one embodiment of the present invention, showing a bag holding one nut with the interest category of “exercise” affixed substantially between the words “the” and “nut”.

FIG. 5 is a perspective view of one embodiment of the present invention, showing a bottle holding nuts with the interest category of “wine” affixed proximate the word “nut”.

### DETAILED DESCRIPTION OF THE PREFERRED EMBODIMENTS

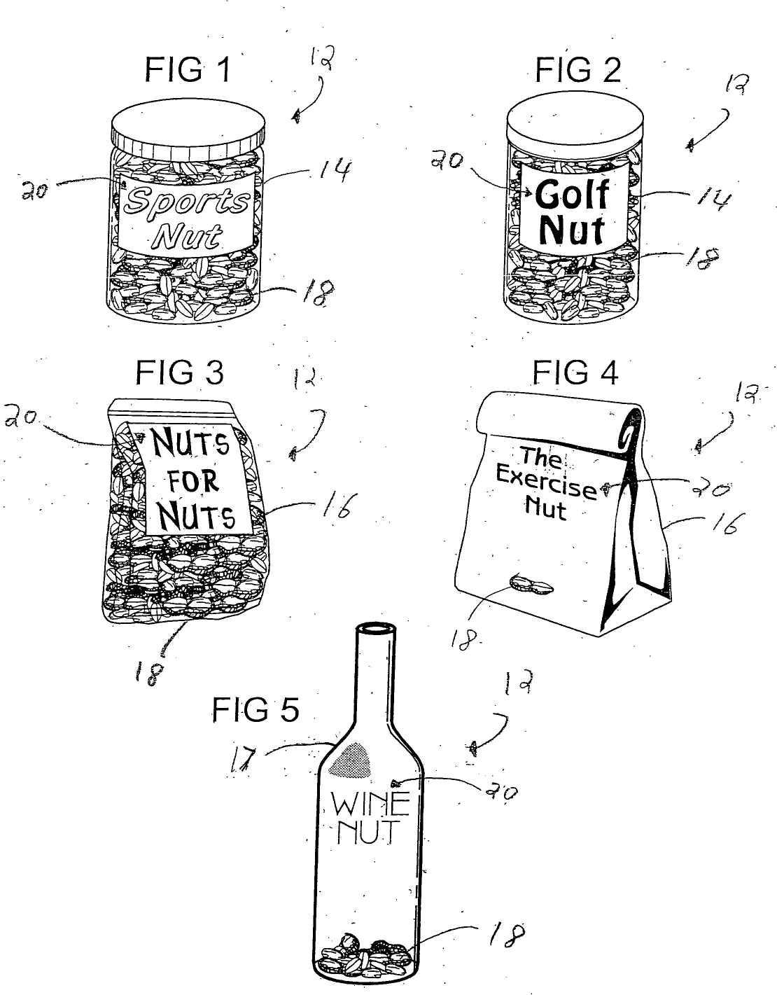

The present invention discloses a method of selling nuts which capitalizes on two meanings of the word “nut”: 1) peanuts, walnuts, pistachio nuts and the like; and 2) an enthusiast, eccentric or other person devoted to a cause, object or pursuit. The first step in the method is to provide a container (referred to generically as container 12, and shown in FIGS. 1-5). The container 12 may be a jar 14 (shown in FIGS. 1-2), a bag 16 (shown in FIGS. 3-4), a bottle 17 (shown in FIG. 5) or any other container 12 capable of holding at least one nut 18. For example, the container 12 may be as small as a form-fitting plastic-type wrapping over a nut 18, so long as the container 12 it is capable of holding at least one nut 18.

After providing a container 12 capable of holding at least one nut 18, the next step in the method of selling nuts 18 of the present invention is to select an interest category (referred to generically as interest category 20). Interest category 20 is any category or topic or subject that may be of interest to an individual or group. Examples of interest categories 20 include, but are not limited to: democratic, republican, patriotic, computer, birthday, football, baseball, basketball, hockey, NASCAR, fishing, hunting, wine, work, beer, sailing, retired, beach, skiing, horse, cat, dog, Fiesta Bowl, Rose Bowl, Cotton Bowl, Orange Bowl, Super Bowl, clean, skating, 4^{th} of July, hiking, exercise, jogging, book, reading, diet, swimming, antique, golf, complete kitchen, baking, cooking, college, music, television, TV, school, professor, chocolate, Harley, Memorial Day, Labor Day, army, navy, air force, and marine. It should be clearly understood that substantial benefit could be derived from other categories of interest, not included in the aforementioned list, such as adjectives (for example, “romantic,” “sentimental,” etc.) so long as the category is descriptive of or an interest of an individual or a group.

After an interest category 20 is selected, the interest category 20 is affixed to the container 12 so as to associate the container 12 having at least one nut 18 with the interest category 20. Preferably, a specific interest category 20 is affixed to the container 12 proximate either the word “nut” or the word “nuts.” For example, referring now to FIG. 1, the interest category 20 of “sports” is affixed proximate the word “nut” on the container 12 so as to associate the interest category 20 of sports with nuts 18. A “sports nut” can refer to a sports enthusiast, sports fan, or someone else with a strong connection to sports. By affixing this interest category 20 to the container 12 of nuts 18, the inventor has increased the interest in buying nuts 18 by allowing an individual to purchase nuts not only for personal consumption, but as a gift, both as a gag gift or a regular gift, for someone else. The attraction to purchasing nuts for those of a particular interest subsequently increases the consumption of nuts, thereby conveying a major health advantage to the public. For example, referring now to FIG. 2, the interest category 20 shown here is “golf”. A container 12 of nuts 18 marked as “golf nut” could be sold in a golf pro shop, as opposed to only at a supermarket or grocery store. By affixing an interest category 20 to a container 12 of nuts 18, and thereby associating the container 12 of nuts 18 with the interest category 20, nuts 18 can be sold at a much greater variety of locations and to a specific interest group, as opposed to only those who enjoy nuts 18.

Referring now to FIG. 4, one embodiment of the method of selling nuts of the present invention is for gag gifts. The container 12 shown in FIG. 4 contains only one nut 18 and includes the interest category “exercise nut,” giving the impression that someone who exercises will not want to eat an entire bag of nuts 18, but instead only a much smaller amount. This is one type of gag gift, but there are many types of interest categories 20 that could be used with one or more nuts 18 to create a comedic effect. In addition, placing the interest category 20 substantially between the word “the” and the word “nut” or “nuts” is another effective way to convey that the container 12 of nuts 18 is associated with a specific category of interest (for example, “The Exercise Nut”).

Referring now to FIG. 5, nuts 18 are placed in a bottle 17 and affixed with the interest category 20 “wine” so as to associate nuts 18 with wine enthusiasts. While, in the preferred embodiment, the interest category 20 is affixed to the container 12 proximate the word “nut” or “nuts,” it should be clearly understood that substantial benefit could be derived from an alternative embodiment of the present invention in which the interest category 20 is affixed to a container 12 without the word “nut” or “nuts.” A wine bottle 16, for example, placed in a wine store or wine section of a store, but filled with nuts 18 may be sufficient to associate nuts 18 with the interest category of wine without the need to use the word “nut” or “nuts” on the bottle 17.

Referring now to FIG. 3, the expression “Nuts for Nuts” is used to identify someone who avidly enjoys or is “crazy” about nuts. An expression or other play on the word “nut” or “nuts” may be used, so long as the expression relates to an interest category 20 and is used to associate the interest category 20 with the container 12 of nuts 18. For example, “Nuts for Love” or some other expression in which “Nuts for” is used proximate an interest category 20 is another effective way of selling nuts within the spirit and scope of the present invention.

While the invention has been particularly shown and described with reference to preferred embodiments thereof, it will be understood by those skilled in the art that the foregoing and other changes in form and details may be made therein without departing from the spirit and scope of the invention.

1. A method of selling nuts comprising, in combination, the steps of:
providing a container having at least one nut;
selecting an interest category;
affixing said interest category to said container so as to associate said container of said at least one nut with said interest category; and
selling said container of said at least one nut.

2. The method of claim 1 further comprising the step of affixing said interest category to said container proximate one of a word “nut” and “nuts”.

3. The method of claim 2 further comprising the step of affixing said interest category to said container substantially between a word “the” and proximate one of a word “nut” and “nuts”.

4. The method of claim 2 further comprising the step of affixing said interest category to said container proximate words “nuts for”.

5. The method of claim 2 wherein said interest category being at least one of: democratic, republican, patriotic, computer, birthday, football, baseball, basketball, hockey, NASCAR, fishing, hunting, wine, work, beer, sailing, retired, beach, skiing, horse,
cat, dog, Fiesta Bowl, Rose Bowl, Cotton Bowl, Orange Bowl, Super Bowl, clean, skating, 4^{th} of July, hiking, exercise, jogging, book, reading, diet, swimming, antique, golf, complete kitchen, baking, cooking, college, music, television, TV, school, professor, chocolate, Harley, Memorial Day, Labor Day, army, navy, air force, and marine.

6. The method of claim 1 wherein said interest category being at least one of: democratic, republican, patriotic, computer, birthday, football, baseball, basketball, hockey, NASCAR, fishing, hunting, wine, work, beer, sailing, retired, beach, skiing, horse, cat, dog, Fiesta Bowl, Rose Bowl, Cotton Bowl, Orange Bowl, Super Bowl, clean, skating, 4^{th} of July, hiking, exercise, jogging, book, reading, diet, swimming, antique, golf, complete kitchen, baking, cooking, college, music, television, TV, school, professor, chocolate, Harley, Memorial Day, Labor Day, army, navy, air force, and marine.

7. A method of selling nuts comprising the steps of:
providing a container having at least one nut;
selecting an interest category;
affixing said interest category to said container proximate one of words “nut”, “nuts” and “nuts for” so as to associate said container of said at least one nut with said interest category; and
selling said container of said at least one nut.

8. The method of claim 7 wherein said interest category being at least one of: democratic, republican, patriotic, computer, birthday, football, baseball, basketball, hockey, NASCAR, fishing, hunting, wine, work, beer, sailing, retired, beach, skiing, horse, cat, dog, Fiesta Bowl, Rose Bowl, Cotton Bowl, Orange Bowl, Super Bowl, clean, skating, 4^{th} of July, hiking, exercise, jogging, book, reading, diet, swimming, antique, golf, complete kitchen, baking, cooking, college, music, television, TV, school, professor, chocolate, Harley, Memorial Day, Labor Day, army, navy, air force, and marine.
